(19) United States
(12) Patent Application Publication
(10) Pub. No.: US 2005/0288980 A1
(43) Pub. Date: Dec. 29, 2005

(54) Application of data envelopment analysis in auditing

(76) Inventors: Ehsan H. Feroz, Duluth, MN (US); Sungsoo Kim, Cherry Hill, NJ (US); Raymond L. Raab, Duluth, MN (US)

Correspondence Address: Schwegman, Lundberg, Woessner & Kluth, P.A., P.O. Box 2938, Minneapolis, MN, 55402, US

(21) Appl. No.: 11/027,750

(22) Filed: Dec. 30, 2004

Related U.S. Application Data
(60) Provisional application No. 60/533,708, filed on Dec. 31, 2003.

(51) Int. Cl. G06F 17/60

(52) U.S. Cl. 705/7

(57) ABSTRACT

A data processing procedure DEA (Data Envelopment Analysis) is described as an analytical tool in an audit engagement. DEA receives data inputs from financial statements of a plurality of clients, constructs efficiency frontiers and evaluates relative income efficiencies. DEA can be used in the overall review stage to detect any anomalies and to assess the reasonableness of financial statements. Application of DEA can significantly minimize errors in an audit judgment by providing accurate and reliable benchmarks and red flags at a reasonable low cost

### RELATED APPLICATIONS

This patent application claims the benefit of priority, under 35 U.S.C. Section 119(e), to U.S. Provisional Patent Application Ser. No. 60/533,708, filed on Dec. 31, 2003, which application is incorporated herein by reference.

### TECHNICAL FIELD OF THE INVENTION

The present invention is related to data processing, and more particularly to the application of Date Envelopment Analysis (DEA) as an analytical tool in auditing.

### BACKGROUND OF THE INVENTION

Analytical procedures employed in the auditing profession involve comparisons of recorded amounts, or ratios developed from recorded amounts, to expectations generated by the auditor. The auditor calculates such expectations by identifying and using plausible relationships that are reasonably expected to exist based on the auditor's understanding of the client and of the industry in which the client operates.

The advantage in this approach is that ratios are easy to compute. On the other hand, they are difficult to interpret when two or more ratios provide conflicting signals. There is a further disadvantage in ratio analysis as different auditors choose different subsets of the available set of ratios in their assessment of the client. This introduces an element of subjectivity in the attempts to compare and assess the overall health of a client.

A way out for this subjective interpretation lies in the use of DEA, occasionally called frontier analysis, which is a performance measurement technique for evaluating the relative efficiency of decision-making units (DMUs).

DEA evaluates the relative income efficiency of a client from a set of firms or decision-making units (DMUs) that exhibit the same multiple inputs and multiple outputs from within the same industry. In one linear programming implementation, DEA constructs an efficient frontier composed of those firms, including the client(s). Those firms that comprise the efficient frontier are income efficient, while those firms not on the efficient frontier are inefficient (enveloped by the efficient DMUs).

DEA is used to evaluate the efficiency of a number of DMUs in the same category. While a typical statistical approach is characterized as a central tendency approach (with emphasize on parameters like mean, median, variance and so on), DEA is an extreme point method and compares each unit with only the “best” unit.

The crucial point in the analysis lies in finding the “best” (may be virtual) unit for each real producer. If the virtual unit is better than the original unit by either making more output with the same input or making the same output with less input, then the original unit is inefficient. The subtleties of DEA are introduced in the various ways that different units can be scaled up or down and combined

One linear program is computed for each client and this procedure determines the unique best transformation relationship that can exist for each client in its industry. For a particular client, the highest weight is chosen for the particular combination of sales and a resource, where the difference between revenue and that resource is the largest. Each particular client chooses the set of weights that maximizes the best use of or case for all of its resources. The remaining firms in the client's industry are constrained to employ that firm's “best practice” set of weights. This approach can simply be described as a linear programming variant of the profit maximization (income efficiency) model.

In a linear programming implementation, DEA constructs an efficient frontier composed of those firms including the client, which consume as little input as possible while producing as much output as possible from the given level of input consumption. Those firms that comprise the efficient frontier are income efficient, while those firms not on the efficient frontier are inefficient (enveloped by the efficient firms).

FIG. 1 represents the production possibility set of a particular industry, consisting of the costs and the sales of a number of firms in that industry.

Mathematically, the test of the income efficiency status of a particular client (firm) is determined by solving a linear program whose objective function minimizes the negative sum on the slacks.

In FIG. 1, the optimal solution of a linear program for each firm yields the necessary information for classifying each firm including the client as income efficient or income inefficient. If the linear program yields an optimal solution with at least one slack variable at a positive amount, then the firm is income inefficient. The frontier or benchmark firms' slacks will all be zero. In FIG. 1, the inefficient firm 7 has a sales slack of s+, and a cost slack of s⁻.

A sensitivity analysis for the additive DEA model defines the necessary simultaneous perturbations to a given firm's inputs and outputs to cause it to move to a state of “virtual” efficiency. Virtual efficiency is defined as a point on the efficient frontier where (i) any minuscule detrimental perturbation (increase in costs and/or decreases in sales) will cause an efficient firm to become inefficient or (ii) any minuscule favorable perturbation (decrease in costs and/or sales in outputs) will cause an inefficient firm to become efficient.

For an efficient firm on the frontier, the stability index defines the largest “cell” in which all simultaneous perturbations to cost and sales will almost cause a change of the efficiency status from income efficient to inefficient. As such, the larger the stability index, the more robustly efficient the firm is considered to be. Those efficient firms with small stability indices will become income inefficient with smaller detrimental perturbations than those efficient firms with larger stability indices

The crucial point in the analysis lies in finding the “best” (may be virtual) unit for each real producer. If the virtual unit is better than the original unit by either making more output with the same input or making the same output with less input, then the original unit is inefficient. The subtleties of DEA are introduced in the various ways that different units can be scaled up or down and combined

One linear program is computed for each client and this procedure determines the unique best transformation relationship that can exist for each client in its industry. For a particular client, the highest weight is chosen for the particular combination of sales and a resource, where the difference between revenue and that resource is the largest. Each particular client chooses the set of weights that maximizes the best use of or case for all of its resources. The remaining firms in the client's industry are constrained to employ that firm's “best practice” set of weights. This approach can simply be described as a linear programming variant of the profit maximization (income efficiency) model.

In a linear programming implementation, DEA constructs an efficient frontier composed of those firms including the client, which consume as little input as possible while producing as much output as possible from the given level of input consumption. Those firms that comprise the efficient frontier are income efficient, while those firms not on the efficient frontier are inefficient (enveloped by the efficient firms).

FIG. 1 represents the production possibility set of a particular industry, consisting of the costs and the sales of a number of firms in that industry.

Mathematically, the test of the income efficiency status of a particular client (firm) is determined by solving a linear program whose objective function minimizes the negative sum on the slacks.

In FIG. 1, the optimal solution of a linear program for each firm yields the necessary information for classifying each firm including the client as income efficient or income inefficient. If the linear program yields an optimal solution with at least one slack variable at a positive amount, then the firm is income inefficient. The frontier or benchmark firms' slacks will all be zero. In FIG. 1, the inefficient firm 7 has a sales slack of s+, and a cost slack of s⁻.

A sensitivity analysis for the additive DEA model defines the necessary simultaneous perturbations to a given firm's inputs and outputs to cause it to move to a state of “virtual” efficiency. Virtual efficiency is defined as a point on the efficient frontier where (i) any minuscule detrimental perturbation (increase in costs and/or decreases in sales) will cause an efficient firm to become inefficient or (ii) any minuscule favorable perturbation (decrease in costs and/or sales in outputs) will cause an inefficient firm to become efficient.

For an efficient firm on the frontier, the stability index defines the largest “cell” in which all simultaneous perturbations to cost and sales will almost cause a change of the efficiency status from income efficient to inefficient. As such, the larger the stability index, the more robustly efficient the firm is considered to be. Those efficient firms with small stability indices will become income inefficient with smaller detrimental perturbations than those efficient firms with larger stability indices.

FIG. 2 exemplifies how the stability index of an efficient firm measures the extent to which the frontier is pushed out.

For an inefficient firm, the stability index defines the largest “cell” in which all simultaneous favorable perturbations (decreases in costs and increases in sales) that must be undertaken to cause the firm to become income efficient or on the frontier. Therefore, the larger the stability index for an inefficient firm, the more robustly inefficient the firm would be. An inefficient firm with a large stability index rests a greater distance from the efficient frontier than an inefficient firm with a smaller stability index. In this program, the stability index measures by how far a particular firm must go to reach the efficient frontier.

FIG. 3 illustrates how the stability index of an inefficient firm measures how far an inefficient firm must go to reach the efficiency frontier

Once the stability index is known for each firm, the firms including the client can be ranked from most robustly income efficient to most robustly income inefficient. To do so, the stability indices for inefficient firms are first negated. Then, the firms can be rank ordered from highest to lowest based on their stability index values. The stability index indicates how far the envelope has been “pushed out” by an efficient firm through the measurement of unfavorable simultaneous changes in the input and output vectors. Or, alternatively, the index indicates how far an inefficient firm must move toward the frontier through the measurement of favorable simultaneous changes in the input and output vectors.

### SUMMARY

According to one embodiment of the inventive matter disclosed herein, DEA (Data Envelopment Analysis), a data processing procedure, is used as an efficient analytical tool in an audit management, especially in the preliminary stage of the audit, to determine the extent of audit and to assess the preliminary risk level of the client.

Another embodiment of the inventive matter disclosed herein, DEA could be employed as an analytical procedure for auditors, in the overall review state of an audit to detect any anomalies and to assess the reasonableness of financial statements.

An yet another embodiment of the inventive matter disclosed herein, DEA based analytical procedures can be used to provide consistent and reliable red flags and benchmarks for auditors to compare a client to other firms in the same industry.

In another embodiment of the inventive matter disclosed herein, an illustrative use of DEA as an analytical procedure is provided for auditing a client in the oil and gas industry.

According to yet another embodiment of the inventive matter disclosed herein is the validation for DEA as an analytical procedure.

### BRIEF DESCRIPTION OF THE DRAWINGS

FIG. 1 represents the production possibility set of a particular industry, consisting of the costs and the sales of a number of firms in that industry

FIG. 2 exemplifies how the stability index of an efficient firm measures the extent to which the frontier is pushed out.

FIG. 3 illustrates how the stability index of an inefficient firm measures how far an inefficient firm must go to reach the efficiency frontier.

FIG. 4 is the table of stability index rankings as a measure of income efficiency for a number of firms in the oil and gas industry.

FIG. 5 is the table containing the outputs and the inputs of the concerned firms listed alphabetically by company name for the ten year period 1989-98.

FIG. 6 lists in a tabular form the data for IMPERIAL OIL LTD for the ten year period 1989-98 under the following fields: long term, common equity, selling and general expense, int./tax expense, cost of goods sold and sales

FIG. 7 is a table of the descriptive statistics of liquidity, activity, performance and capital structure ratios for all firms in the three industries: Oil and Gas, Pharmaceutical and Primary Metal.

FIG. 8 presents the Pearson and Spearman correlation matrices for all firms under this study in a tabular form

FIG. 9 presents in a tabular form the mean difference t-test results between High and Low Stability Index Ranking groups for all firms in the three industries: Oil and Gas, Pharmaceutical and Primary Metal.

### DETAILED DESCRIPTION OF THE INVENTIVE SUBJECT MATTER

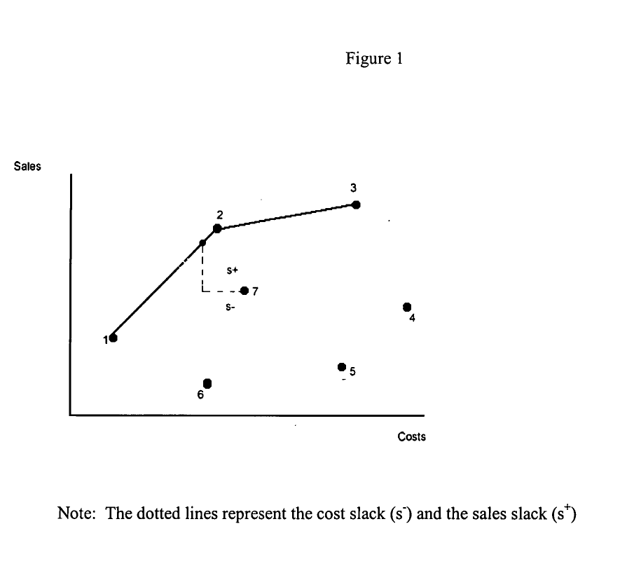

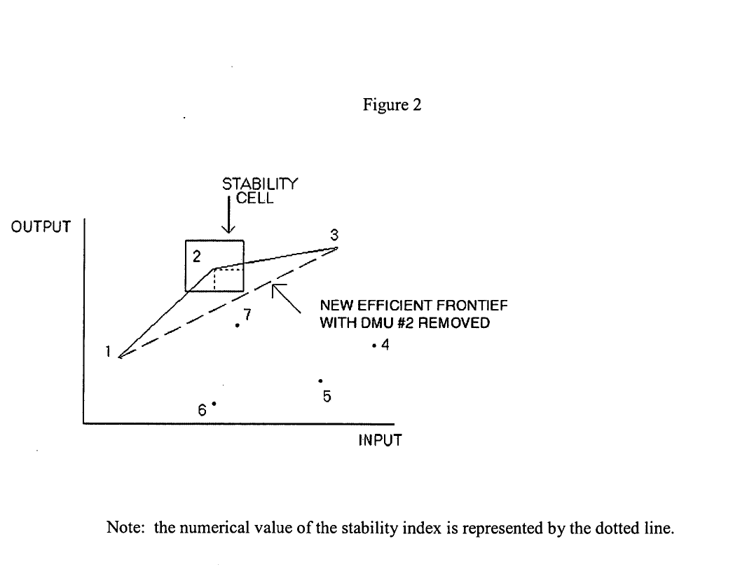

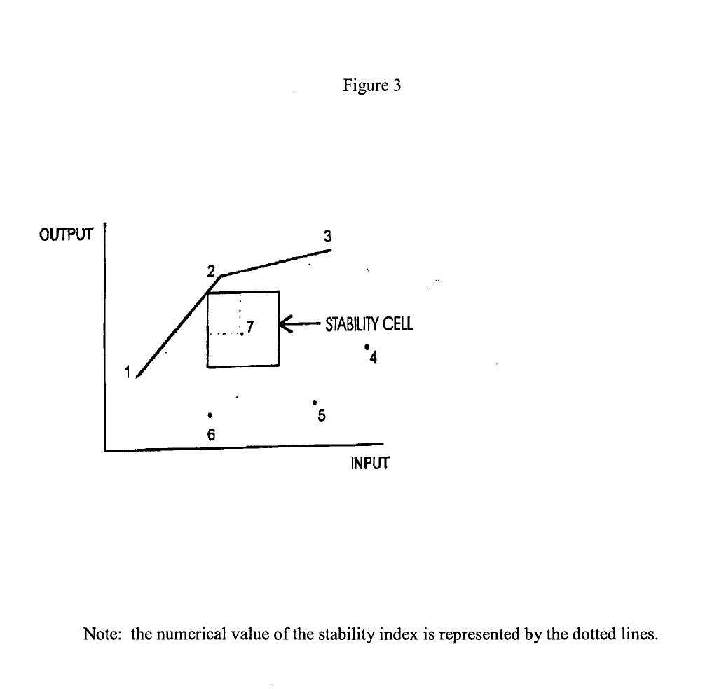

According to one embodiment of the inventive subjective matter, the use of the DEA stability index rankings (a single composite measure generated by the DEA software), by auditors auditing specific client(s) in the oil and gas industry is illustrated in the following. Stability index rankings, although technically a measure of sensitivity to changes in the output and inputs, can be interpreted as a radial measure to the efficient frontier (for firms below the frontier) or by how much the existing frontier has been “pushed out” for firms already on the frontier. Stability index values provide the rankings of firms within a particular industry from the most income efficient (lowest numbered rank) to the least efficient firm (highest numbered rank). FIGS. 1, 2 and 3 illustrate typical instances of these concepts with respect to the statistics of a set of 7 firms in a particular industry.

The stability index efficiency rankings provide the auditor with an over all or composite measure, as compared to a set of ratios with possibly conflicting signals, for verifying the relative performance of a particular client(s) over the ten years in this example.

The oil and gas industry, chosen in part because of its familiarity to most auditors, provides an illustrative example of one embodiment of the inventive matter herein, by means of a DEA income efficiency analysis

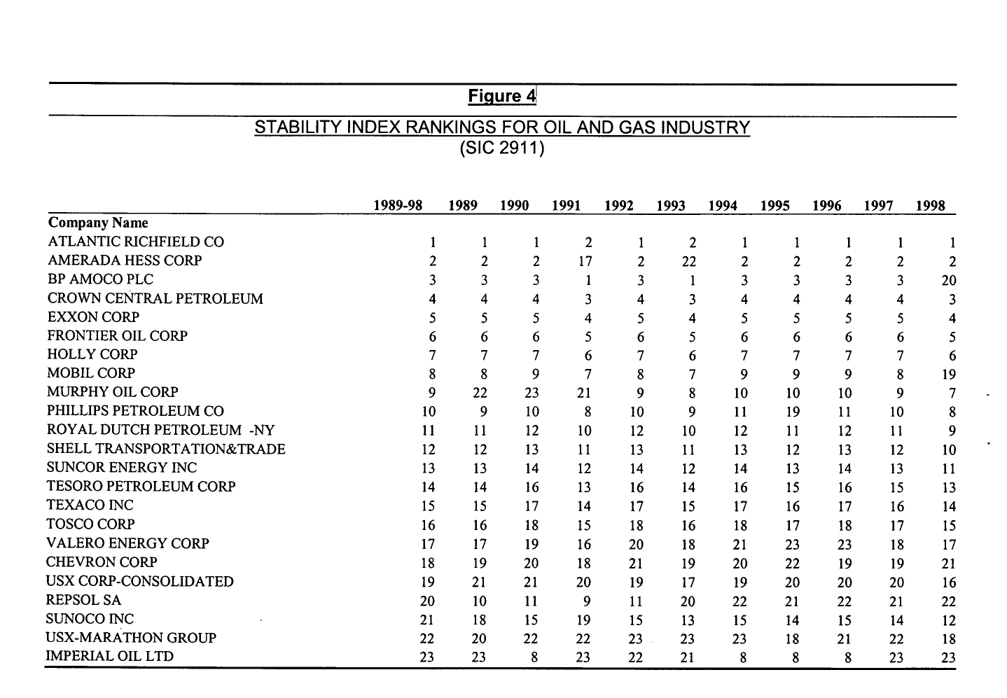

FIG. 4 is an array of stability index rankings as a measure of income efficiency for a number of firms in the oil and gas industry. The companies' overall stability rankings for the 1989-98 period appear on the leftmost column of numbers. The columns to the right indicate the annual income efficiency ranking for each year individually.

Comparisons of annual rankings “wash out” the effect of macroeconomic events that influence the industry in a uniform way. Firm (client) specific events are the drivers of change in rankings for the given year. On the average, the annual rankings appear quite stable relative to the combined period 1989-98. Atlantic Richfield ranked first appears to be uniformly the most income efficient firm over the period, while Imperial Oil ranked last at 23rd appears to be the least efficient (most income inefficient) in the industry as a whole.

The output and inputs of Atlantic Richfield and Imperial Oil are studied to compare their transformations.

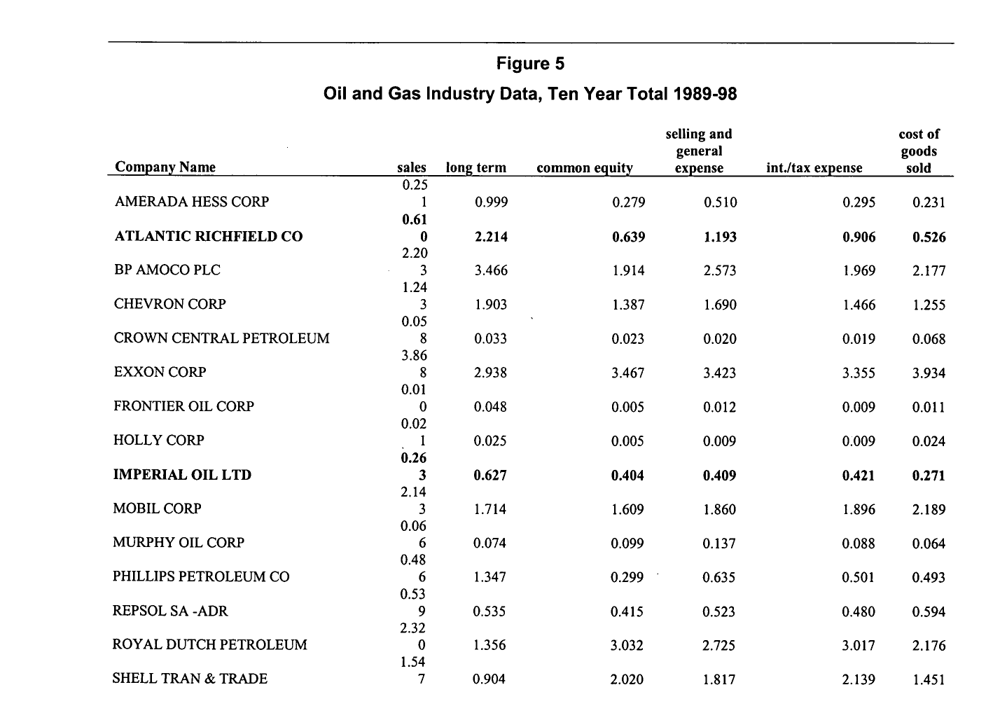

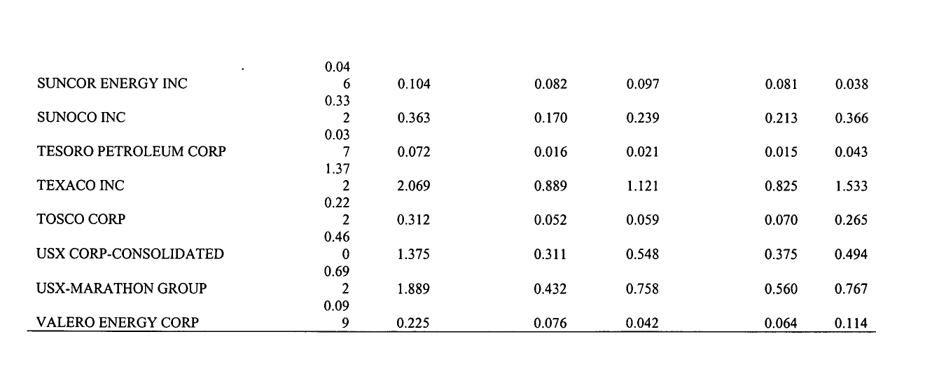

FIG. 5 records the outputs and the inputs of the concerned firms listed alphabetically by company name for the ten year period 1989-98.

Atlantic Richfield's transformed sales (row in bold print) are 2.3 times larger than Imperial's (0.610 v. 0.263); yet common equity is only 1.6 times larger (0.639 v. 0.404); and interest and tax expense is only 2.2 times larger (0.906 v. 0.421); and cost of goods sold is only 1.9 times larger (0.526 v. 0.271). Imperial's linear program weights these components, especially common equity and cost of goods sold, the most highly. Moreover, during a 10 year period, it would be critically important that the firm's (client's) transformed sales exceed the transformed cost of goods sold (col. (1) v. (6)). As expected, this is true for Atlantic Richfield (0.610 v. 0.526), but not for Imperial (0.263 v. 0.271).

Although FIG. 4 ranks Imperial Oil as the relatively most income inefficient firm (23rd), Imperial Oil exhibits several relatively efficient years, ranked eighth during 1989, 1994-1996. ProQuest's Information Service reports the strategic moves by Imperial's management and traces the input and output changes that account for the switching of ranks. ProQuest (Jan. 21, 1989) reports Canadian based Imperial (which is controlled by Exxon) completed a massive asset purchase of $4.5 billion from the once bankrupt oil giant Texaco from Texaco Canada Inc., due to Texaco's ill-fated courtroom battle with Pennzoil. “It looks like a fairly good deal for both parties,” said Charles Andrew, a senior vice president at John S. Herold Inc., a Greenwich, Conn. oil and gas research firm.

For the years 1994-96, ProQuest (Jan. 14, 1994) reports Imperial's plans to sell a profitable Alberta fertilizer plant and Canadian Prairies distribution terminals to Sherritt, a Fort Saskatchewan resource and advanced materials manufacturing company. In 1995, according to ProQuest (Apr. 3, 1995), Imperial put into effect a cost-cutting plan unveiled in 1994, and planned to shut down a petroleum refiner in British Columbia by the end of July 1995. In 1996, according to ProQuest (Jun. 25, 1996), Imperial announced a program to repurchase a substantial amount, as much as 13 percent, of its outstanding shares.

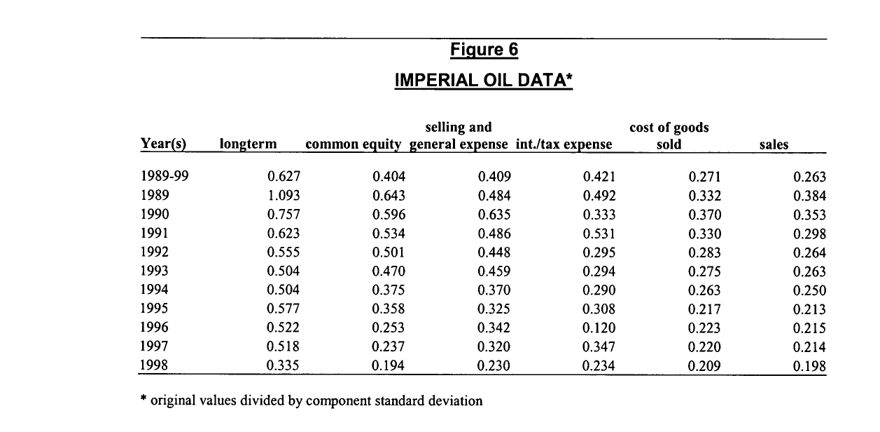

FIG. 6 lists the data for IMPERIAL OIL LTD for the ten year period 1989-98 under the following fields: long term, common equity, selling and general expense, int./tax expense, cost of goods sold and sales.

Looking at Imperial's long term debt and common equity balances from 1988-98 in FIG. 6, an auditor might infer an Imperial (Exxon) strategy of trading assets greatly effected its economic fortunes, and these can be traced through the income statements and balance sheet changes. The switching in stability rankings provide a potential attention directing red flag for auditors to be alert to possible misstatements and to verify the reliability of the reported data by the client and the operating efficiency with which the client is pursuing its strategy, as compared to other firms in the same industry (or as compared to its own performance over a defined range of time series). The client's strategies vis a vis its competitors' strategies can be verified by obtaining additional information from inside the company and outside industry sources. The combined period column in FIG. 6 provides an overall summary. The auditor can observe the limits to his (her) client's profitability, asset utilization, and leverage vis a vis its competitors by visually observing the actual values of variables employed by the DEA analysis.

Validity of DEA as an analytical procedure is demonstrated by applying the method to the traditional ratios used by auditors and verifying empirically that DEA stability index values have properties similar to those of commonly used ratios.

Three unrelated industries, oil and gas, primary metal and pharmaceuticals were selected for validation test. These industries were selected because of their familiarities to the auditors, the homogeneity of their core businesses, and the intensity of their competition within the respective industries.

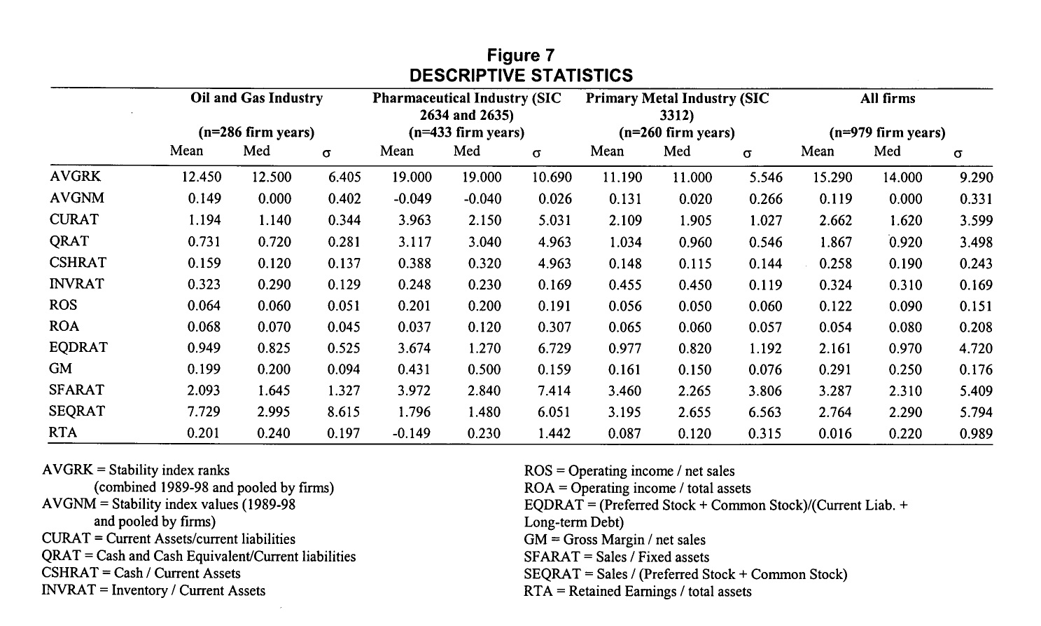

FIG. 7 contains the descriptive statistics of liquidity, activity, performance and capital structure ratios for all firms in the three industries: Oil and Gas, Pharmaceutical and Primary Metal.

The mean and median values of each ratio appear to be consistent with the published values and generally represent COMPUSTAT firms and industries. Very small differences between the mean and median values of the ratios are observed. The pharmaceutical industry turns out to be more liquid and profitable than the other two industries.

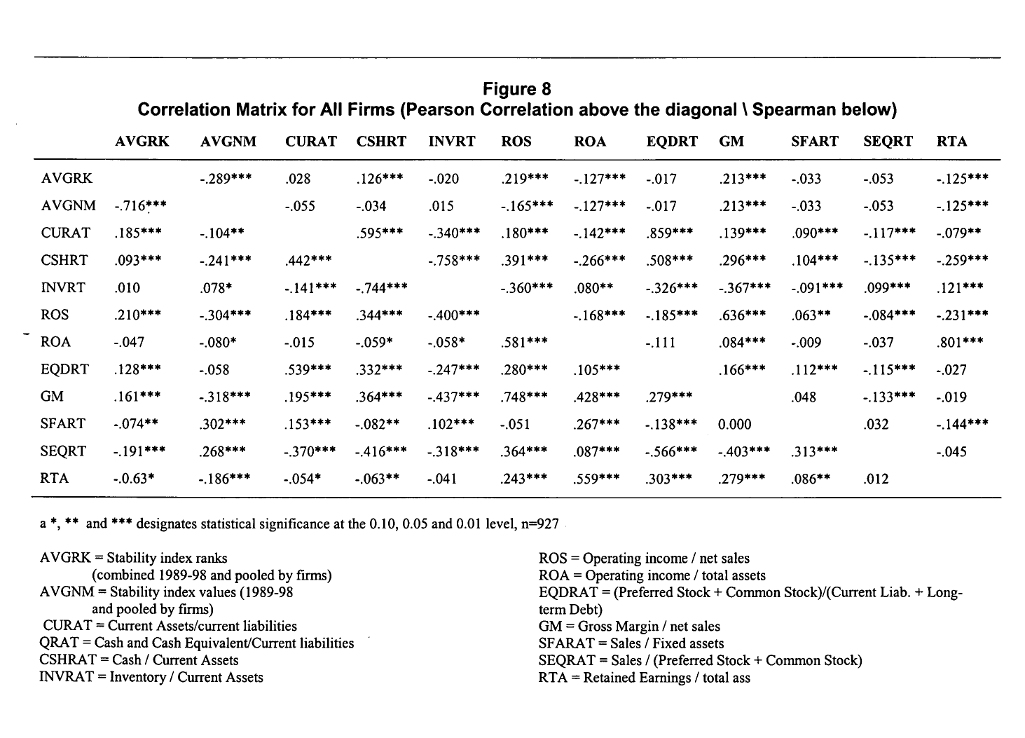

FIG. 8 presents the Pearson and Superman correlation matrices for all firms under this study. This is used to conduct a preliminary check of the presence of multicollinearity among test variables.

Each ratio belongs to one of the four groups of ratios that auditors frequently compute: liquidity (CURAT, CSHRT, INVRT), performance (ROS, ROA and GM), capital structure (EDDRT, SEQRT, RTA), and activity (SFARAT). The correlation coefficients among variables within the same group are, as expected, highly correlated.

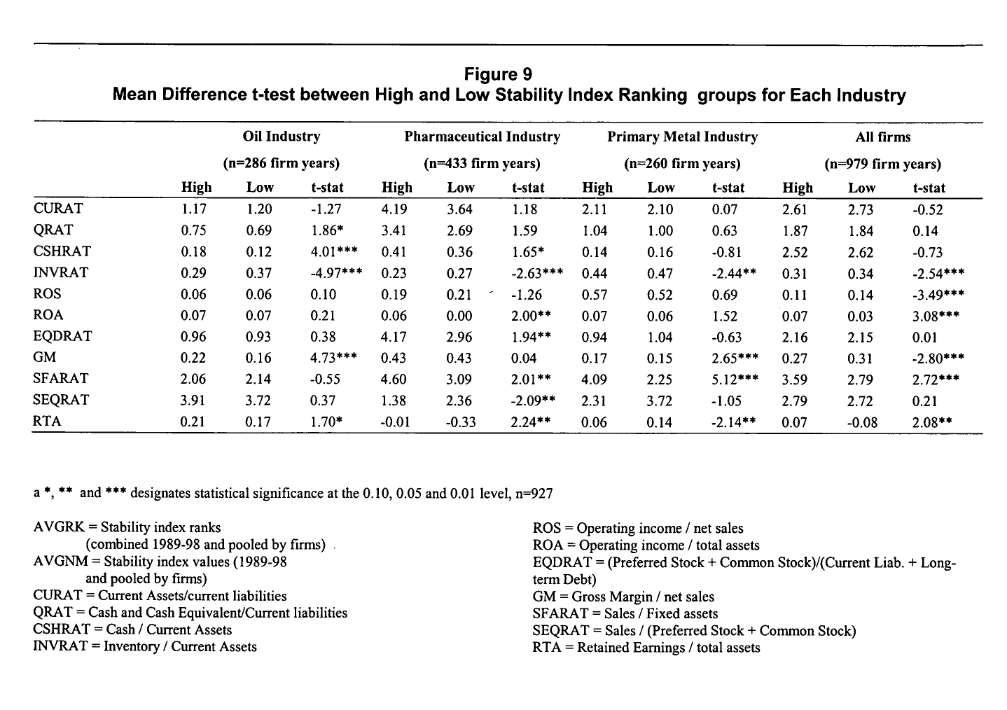

FIG. 9 is the report of mean difference t-test results between High and Low Stability Index Ranking groups for all firms in the three industries: Oil and Gas, Pharmaceutical and Primary Metal. The high performers are the efficient firms and the low performers are the inefficient firms.

The results show, among others, low performers have higher level of inventory, good performers have higher ROA and asset turnover, as expected. In an univariate context, high and low classification based on stability index rankings within the industry does indeed have discriminating power in terms of inventory, asset turnover and ROA differences.

The above embodiment of the inventive subject matter herein has amply demonstrated that DEA is a much more systematic approach as compared to a traditional ratio analysis since DEA compares the client's income efficiency as compared to other firms in the same industry or the same client over a period of time, by using the same benchmark, i.e., same set of inputs and outputs.

According to another embodiment of the inventive subject matter herein, DEA can be used for detecting potential misstatements in the reports of single client by comparing the stability index values of the client to its own historical profile and to the industry benchmarks or other expectations developed by the auditor based on his/her familiarity with the industry and the client.

According to yet another embodiment of the inventive subject matter herein, the comparison of the stability index rankings of a client, over a period of time, using DEA could help the auditor detect red flags which call for more detailed investigations.

According to another embodiment of the inventive subject matter herein, DEA can provide comparative business performance measures either for the same client as compared to the rest of the firms in the industry or the same client over a period of time.

According to one more embodiment of the inventive subject matter herein, DEA can be used to summarize or integrate more financial and non-financial business measurement data than can be done with individual ratios. In this embodiment, DEA provides a much more composite approach since it encompasses the information embodied in a large number of ratios in a smaller group of inputs.

According to one more embodiment of the inventive subject matter herein, DEA has the advantage over traditional ratio analysis, which is often conducted on a one-ratio-at-a time basis. While it is also possible to look at number of ratios as a part of analytical procedure, the auditor faces a judgment call when two or more ratios provide conflicting signals. In this sense, by showing the relationship of the same set of inputs to a single output, DEA minimizes errors in judgment by providing a summary measure, which is not based on subjective judgment of sometimes-conflicting weights.

In yet another embodiment of the inventive subject matter herein, DEA provides flexibility to the auditor in terms of choice of inputs and outputs (which can be either physical units or dollar amounts). DEA has been shown to determine the operating income efficiency of the clients using the relationship of a set of financial inputs; In addition, DEA can also be designed for other audit judgments emphasizing the clients' long-term competitive position, or acceptable cut off points for allowance for uncollectible accounts, etc.

According to one more embodiment of the inventive subject matter herein, DEA provides a choice to the auditor in terms of either a cross sectional approach or a time series interpretation. The cross sectional approach can be limited to a year or a quarter or even a smaller time frame depending on the preference of the auditor. An auditor can also choose the benchmark (frontier) which can be based on one industry over time, a subset of an industry, or even a subset of competitors, depending on the auditor's judgment regarding appropriate expectations for a particular client. If the analysis calls for a longer time period, it is possible to use as long a historical time series as may be deemed necessary for an audit judgment.

According to one more embodiment of the inventive subject matter herein, DEA can incorporate both operating and financial data into a model as opposed to other “Tests of reasonableness” that usually involve only operating data.

According to one more embodiment of the inventive subject matter herein, DEA also provides a choice in terms of quality of data to be used by an auditor. It can be published financial data (as in our case in the absence of proprietary data), or data coming from trial balance, or even forecasted data. Indeed, one of the advantages of DEA is non-comparable inputs based on information expressed ratio, ordinal, categorical and interval measures used simultaneously as inputs into a units invariant DEA analytical procedure.

According to one more embodiment of the inventive subject matter herein, in terms of cost benefit analysis, DEA can significantly minimize errors in audit judgment by providing accurate and reliable benchmarks and red flags at a reasonably low cost.

According to one more embodiment of the inventive subject matter herein, DEA software are generally user friendly and can be developed in house by auditing firms with minimum resource commitments. The cost of training auditors in DEA programming is small as compared to the cost of errors in audit judgment that can lead to potentially expensive litigations.

### REFERENCES

AICPA. 1998. Audit and Accounting Guide: Audits of Entities with Oil and Gas Producing Activities. New York: American Institute of Certified Public Accountants.
AICPA. 1988. Statement on Auditing Standards #56, Analytical Procedures. New York: American Institute of Certified Public Accountants.
Anderson, V., W. W. Cooper and D. Lockhart. 1994. “DEA Evaluation of Performance Audits.” Internal Auditing Vol. 10, pp. 13-22.
Arens, A. R. Elder, and M. Beasley. 2003. Auditing: An Integrated Approach, (ninth edition). Englewood Cliffs, N.J.: Prentice Hall.
Biggs, S., Knechel, W. R., Walker, N., Wallace, W., and J. Willingham. 1995. “Analytical Procedures” in T. Bell and A. Wright eds. Auditing Practice, Research and Education. New York: AICPA: 110-143.
Charnes, A., Rousseau, J. J. and Semple, J. H. 1996, “Sensitivity and Stability of Efficiency Classification in Data Envelopment Analysis,” The Journal of Productivity Analysis, 7, 5-18.
Charnes, A., Cooper, W. W., Golany, B., Seiford, L., and Stutz, J. 1985. “Foundations of Data Envelopment Analysis for Pareto-Koopmans Efficient Empirical Production Functions.” Journal of Econometrics 30: 91-107.
Charnes, A., Haag, S., Jaska, P., and Semple, J. 1992. “Sensitivity of Efficiency Classifications in the Additive Model of Data Envelopment Analysis.” International Journal of Systems Science 23: 789-798.
Coakley, J. R. and C. E. Brown. 1993. “Neural Networks Applied to Ratio Analysis in the Analytical Review Process.” International Journal of Intelligent Systems in Accounting, Finance and Management. 2:1 (January) 19-39.
Cooper, W. W., Li, S., Seiford, L. M., Tone, K., Thrall, R. M., Zhu, J. 2001. “Sensitivity and Stability Analysis in DEA: Some Recent Developments.” Journal of Productivity Analysis, 15, 217-246.
Farrell, N. J. 1957. “The Measure of Productive Efficiency.” The Journal of the Royal Statistical Society. 120: 253-290.
FASB. 1996. Statement of Financial Accounting Standards No. 128, Earnings Per Share. Norfolk, Conn.: Financial Accounting Standards Board.
Feroz, E. H., T. Kwon, V. S. Pastena, and K. Park. 2000. “The Efficacy of Red Flags in Predicting the SEC's Targets: An Artificial Neural Networks Approach.” International Journal of Intelligent Systems in Accounting, Finance, and Management 9: 145-157.
Feroz, E. H., Raab, R. and Haag, S. 2001. “An Income Efficiency Model Approach to the Economic Consequences of OSHA Cotton Dust Regulation.” Australian Journal of Management, 26: 69-89.
Feroz, E. H., S. Kim and R. Raab. 2003. “Financial Statement Analysis: A Data Envelopment Analysis Approach.” Journal of the Operational Research Society.
Kinney, W. R., 1987. “Attention Directing Analytical Review Using Accounting Ratios: A Case Study.” Auditing: A Journal of Practice and Theory (Spring): 59-73.
Lovell, C. A. K., and Pastor, J. T. 1995. “Units Invariant and Translation Invariant DEA Models.” Operations Research Letters, 18. ProQuest Information Services. Bell and Howell Information and Learning.
Seiford, L. and Zhu, J., “Stability Regions for Maintaining Efficiency in Data Envelopment Analysis.” European Journal of Operations Research, 108, 1998, 127-139.
Sherman, H. D. 1984. “Data Envelopment Analysis as a New Managerial Audit Methodology-Test and Evaluation.” Auditing: Journal of Practice and Theory. Vol. 4, No. 1, 35-53.
Smith, P. 1990. “Data Envelopment Analysis Applied to Financial Statements.” Omega 18: 131-138.
Thanassoulis, et al. 1996. “A Comparison of Data Envelopment Analysis and Ratio Analysis as Tools for Performance Assessment.” Omega, 24: 229-244.
Turner, J. L. 1997. “The Impact of Materiality Decision on Financial Ratios: A Computer Simulation.” Journal of Accounting Auditing and Finance (Spring): 125-147.

1. A method comprising measuring the efficiency of a revenue producing organization using data envelopment analysis.

2. A method according to claim 1 including auditing an organizations financial viability.

3. A method comprising measuring efficiency of a revenue producing organization by using data envelopment analysis to analyze a plurality of financial or performance data ratios related to the financial status of a company.

4. A method according to claim 3 wherein the ratios include a debt to equity ratio.

5. A method comprising evaluating the relative financial performance of an entity or set of entities on a comparable metric of same multiple inputs and outputs.

6. A computer system comprising a data storage unit that holds financial or performance data for a revenue producing organization and a computational unit configured to compute the efficiency of the revenue producing organization using data envelopment analysis.

7. A computer system comprising a data storage unit that holds financial or performance data for a revenue producing organization and a computational unit configured to compute an efficiency measure for the revenue producing organization by using data envelopment analysis to analyze a plurality of financial or performance data ratios related to the financial status of a company.

8. A computer system according to claim 7 wherein the ratios include a debt to equity ratio.

9. A computer system comprising a data storage unit that holds financial or performance data for a revenue producing organization and a computational unit configured to compute an evaluation of the relative financial performance of an entity or set of entities on a comparable metric of same multiple inputs and outputs wherein such computation is performed using data envelopment analysis.

10. A computer system comprising a data storage unit that stores financial or performance data for a revenue producing organization and a computational unit configured to compute the financial viability of an organization using data envelopment analysis.

11. An article of manufacture comprising a data storage element that stores financial or performance data for a revenue producing organization and a computer program operable on a computing system to compute the efficiency of the revenue producing organization using data envelopment analysis.

12. An article of manufacture comprising a data storage element that stores financial or performance data for a revenue producing organization and a computer program operable on a computing system to compute an efficiency measure for the revenue producing organization by using data envelopment analysis to analyze a plurality of financial or performance data ratios related to the financial status of a company.

13. An article of manufacture according to claim 12 wherein the ratios include a debt to equity ratio.

14. An article of manufacture comprising a data storage element that stores financial or performance data for a revenue producing organization and a computer program operable on a computing system to compute an evaluation of the relative financial performance of an entity or set of entities on a comparable metric of same multiple inputs and outputs wherein such computation is performed using data envelopment analysis.

15. An article of manufacture comprising a data storage element that stores financial or performance data for a revenue producing organization and a computer program operable on a computing system to compute the financial viability of an organization using data envelopment analysis.
